(19) United States
(12) Patent Application Publication
(10) Pub. No.: US 2009/0133723 A1
(43) Pub. Date: May 28, 2009

(54) TIRE WASHING STATION

(76) Inventor: Urs Frutiger, Winterthur (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/916,862

(22) PCT Filed: Jun. 10, 2005
(86) PCT No.: PCT/CH05/00325

§ 371 Date: Jul. 10, 2008

(51) Int. Cl. B08B 3/04

(52) U.S. Cl. 134/104.2

(57) ABSTRACT

The tyre washing unit comprises a contaminated water container (1), above which a working region (BE) is arranged, through which a vehicle for cleaning is to be driven and on which a spray generator supplied by a central supply system is arranged. According to the invention, at least one extension arm (2) is connected to the working region (BE) comprising an extension supply system, connected to the central supply system. The extension supply system supplies further spray generators embodied on the extension arm (2).

The invention relates to a tire washing station according to the preamble of claim 1.

There are numerous situations—for example in the region of construction sites, quarries and landfills—in which it is necessary to wash the tires of a truck before it leaves the mission site and drives onto public roads, in order to keep the roads clean and safe for traffic. Tire washing stations of the kind mentioned at the beginning are employed for this purpose.

GB 2 347 846 describes a tire washing station of the stated kind, which comprises an open-topped dirty water collecting vessel over which there is disposed a grate that is to be driven over by the vehicle to be washed. To both sides of the grate, extending in its longitudinal direction, there is a pipe provided with nozzles for generating an inwardly directed jet of water. Running beneath the grate are two further pipes having upwardly directed nozzles for generating an upwardly directed jet of water.

Because the drive-over length of the grate is as a rule much shorter than the rolling length of a wheel, that is, the circumference of the wheel, no uniform, complete cleaning of the wheel can occur. In comparison with conventional stationary or costly mobile systems having correspondingly long treatment regions having separate basins, this disadvantage has worked in favor of the compact mobile design.

The object of the invention was to propose such a tire washing station that overcomes this disadvantage.

This object is achieved with the features of the characterizing part of claim 1. Further embodiments of the invention are defined in further claims 2 to 8.

The tire washing station exhibits a dirty water collecting vessel above which there is located a treatment passage, through which a vehicle to be washed is to be driven and on which there are disposed jet generators fed via a central supply system. Disposed adjacently to the treatment passage is at least one extension flap, which comprises an extension supply system and feeds further jet generators fashioned on the extension flap. By virtue of this extension flap, the treatment passage as a whole is lengthened in such fashion that comprehensive cleaning of the whole tire can occur without any sacrifice in terms of the compactness of the system.

For example, there are fashioned two extension flaps that are disposed oppositely to each other adjacently to the treatment passage. Here the treatment passage as a whole is advantageously made symmetrical if equally large extension flaps are used. In particular, the use of the same or identical components for both extension flaps results in an economical and compact structure.

For example, the extension flap or flaps are separably fastenable to the dirty water collecting vessel, and the extension supply system or systems are separably connectable to the central supply system, the separable connection of the extension flaps to the dirty water collecting vessel being effected in known fashion, for example by a screw connection. In this way an especially favorable and space-saving disposition of the components is brought about for storage and transport. For example, all components of such a tire washing station can be stored and transported in conventional containers. In the case of typical dimensions, two such tire washing stations can be placed complete in a 20-foot standard container.

For example, the treatment passage and the extension flap or flaps together form a drive-over surface whose length in the drive-through direction is at least 300 cm. In this way the length of the treatment region as a whole is roughly in the range of the circumference of an ordinary truck tire.

For example, the dirty water collecting vessel is fashioned as open in the shape of a box or rectangular prism, and the extension flap or flaps each extend outwardly away from each other from the upper edges of mutually opposite side walls of the dirty water collecting vessel. In this way the dirty water runs, without further means, into the central region of the system and from there can drain downwardly into the dirty water collecting vessel. From there the water can be re-injected into the central supply system by a pump, the dirt being collected and deposited in the bottom region.

For example, the extension flap or flaps extend outwardly, each with an upward trend, from the dirty water collecting vessel and/or exhibit a bottom having a gradient falling toward the dirty water collecting vessel, so that dirty water impinging on the bottom of the extension flaps flows to the dirty water collecting vessel by the action of gravity.

For example, the extension supply system is connected to the central supply system. In this way the extension supply system utilizes the pump of the central supply system and is connected, for example directly or via additional pipes, to the existing piping system.

For example, the extension supply system is connected directly to the dirty water collecting vessel and has its own drive. As a rule a pump is used as drive. In this way the extension supply system is operable independently of the central supply system.

A tire washing station according to the invention is more compact than known tire washing stations for an equal overall length of the treatment region. It can be set up and put in service in simple fashion and without major structural adaptations to the surroundings, which is advantageous precisely, for example, in the case of road construction projects with dynamically changing treatment locations.

In what follows, an exemplary embodiment of the invention is described in greater detail with reference to the Drawings, in which:

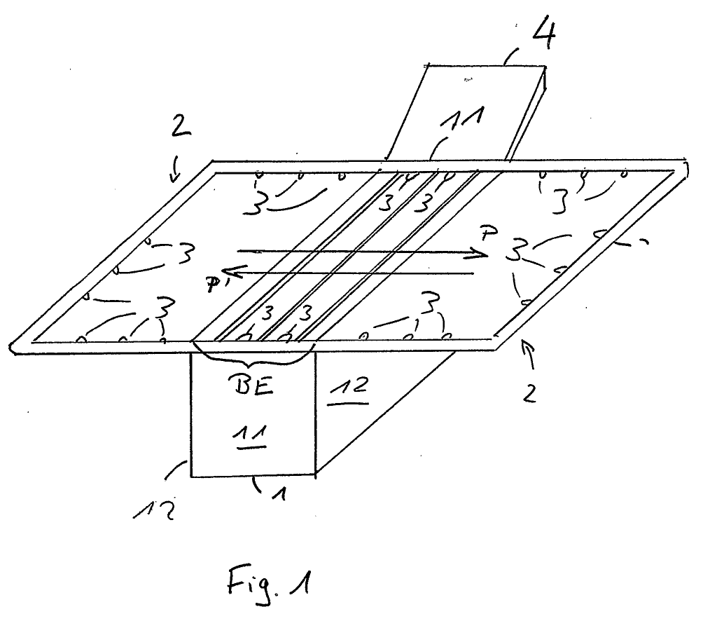

FIG. 1 depicts, in schematic perspective representation, a tire washing station according to the invention;

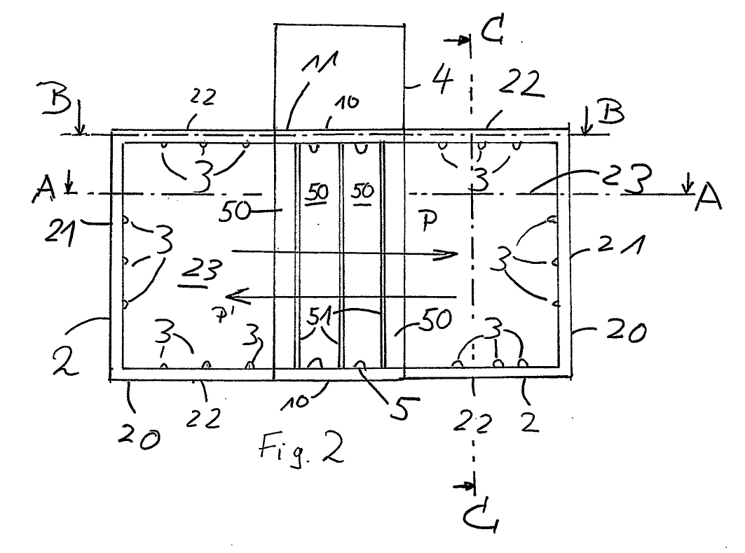

FIG. 2 depicts schematically, in top view, a tire washing station according to the invention;

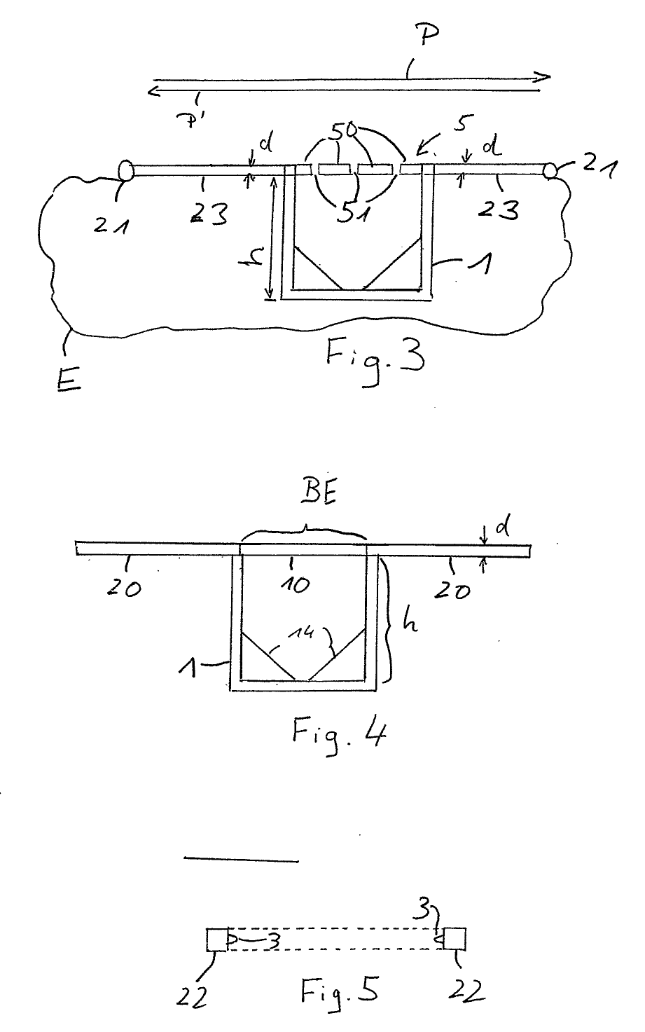

FIG. 3 is a section along line A-A according to FIG. 1;

FIG. 4 is a section along line B-B according to FIG. 1; and

FIG. 5 is a section along line C-C according to FIG. 1.

FIG. 1 depicts schematically and in perspective view a tire washing station according to the invention, which comprises first an open-topped dirty water collecting vessel 1, which serves to accommodate dirty water produced by the cleaning of tires. A known dirt conveying apparatus 4 for conveying mud from dirty water collecting vessel 1 is disposed at one of the ends 11 of dirty water collecting vessel 1.

Above dirty water collecting vessel 1 is a treatment passage BE, which is defined by a load-bearing device described in FIG. 2, is to be driven through in drive-through direction P, P′ by the vehicle to be washed, and extends in drive-through direction P, P′ over the entire length of the opening of dirty water collecting vessel 1.

Disposed along treatment passage BE are jet generators 3 for generating jets of water for cleaning the tires.

FIG. 2 depicts schematically, in top view, a tire washing station according to the invention. Mounted on the opening of dirty water collecting vessel 1 is the load-bearing device, which is driven over by vehicles in drive-through direction P, P′ during cleaning and is fashioned as a grate 5 in the exemplary embodiment illustrated. Connected to the upper edge of dirty water collecting vessel 1 are two extension flaps 2, which are provided for extending or lengthening treatment passage BE in drive-through direction P, P′, are each attached to one of the two longitudinal sides 12 of the dirty water collecting vessel and extend outwardly away from treatment passage BE.

Grate 5 comprises bars 50 that extend transversely to drive-through direction P, P′. Spaced-apart bars 50 form between them slots 51, through which the dirty water generated in tire cleaning passes into dirty water collecting vessel 1.

Further provided on dirty water collecting vessel 1 is a central supply system, which serves to feed the jet generators, that is, to deliver water to the jet generators. In the exemplary embodiment illustrated, the central supply system comprises two central pipes 10, which extend at the edge of dirty water collecting vessel 1 along its ends 11 while, in the exemplary embodiment illustrated, jet generators 3 are known spray nozzles 3 provided on the central pipes and disposed at intervals on a line.

Each of extension flaps 2 comprises a body 23, which is driven over by vehicles in the drive-through direction P, P′ during cleaning, as well as an extension supply system, which is in flow connection with the central supply system and serves to deliver water to further jet generators provided on extension flaps 2, said jet generators likewise being for example spray nozzles 3.

In the exemplary embodiment illustrated, the extension supply system is an extension pipe 20 bent into a U shape, which runs on the edge of body 23 and comprises two arm sections 22 of rectangular cross section disposed parallel to each other as well as a base section 21.

It is conceivable to fashion the disposition comprising central pipes 10 and both extension pipes 21 in one piece.

In a special embodiment in which extension flaps 2 are separably fastenable to dirty water collecting vessel 1 and extension pipes 20 are separably connectable to central pipe 10, the hookup of extension pipe 20 to both central pipes 10 is effected in known fashion using pipe connectors such as for example sleeves. This embodiment is advantageous because the tire washing station can be broken down into individual parts that can be stowed in space-saving fashion for transport.

Central pipe 10 and both extension pipes 20 represent a continuous pipe system to which water under pressure is supplied via a connection (not illustrated) to a pump (not illustrated), which water is forced through spray nozzles 3 and shaped into a jet of water.

The contaminated wash water flows back into dirty water collecting vessel 1 and is reused after cleaning. The quantity of water lost upon each vehicle washing is made up, for example automatically.

In principle it is also conceivable to provide the tire washing station with only one extension flap 2, it being clear to an individual skilled in the art that in either case both central pipes 10 must be connected to each other.

It is also conceivable to provide rollers instead of grate 5 as load-bearing device, said rollers being disposed parallel and spaced apart from each other between ends 11 of the dirty water collecting vessel.

It is pointed out that spray nozzles 3 can also be disposed at a different position from what is depicted in the exemplary embodiment. It is conceivable for example to place bottom spray nozzles beneath grate 5, which bottom spray nozzles generate an upwardly directed jet passing through slots 51.

FIG. 3 is a section along line A-A in FIG. 2. Dirty water collecting vessel 1 is sunk into earth E in such fashion that grate 5 is disposed in the plane of the ground surface and both extension flaps 2 have their bodies 23 supported on the ground.

Grate 5 together with bodies 23 of both extension flaps 2 defines a surface to be driven over in drive-through direction P, P′ by the vehicle to be washed, which surface differs slightly from the plane because the grate is disposed horizontally while the extension flaps extend outwardly from dirty water collecting vessel 1 with a slight upward trend, at an angle of roughly 11 to 5° relative to the horizontal. In other words, extension flaps 2 fall toward dirty water collecting vessel 1, so that the dirty water impinging on bodies 23 flows back into dirty water collecting vessel 1 under the action of gravity. This can also be achieved for example by fashioning extension flaps 2 so as to have a wedge shape in longitudinal section in drive-through direction P or P′ respectively, with the tip toward dirty water collecting vessel 1. The ground area around dirty water collecting vessel 1 can advantageously be simply subjected to light grading or, if soil conditions are favorable, can be left practically untreated. Extension flaps 2 fashioned in wedge shape can then simply be laid on this ground area and supported thereon, the dirty water then being able to flow immediately back into dirty water collecting vessel 1.

Treatment passage BE and the extension flaps together form a drive-over surface whose dimension in drive-through direction P, P′ is equal to or greater than roughly the circumference of a truck tire. Thus the treatment region extends in drive-through direction P, P′ over a total length that is at least in the region of a truck tire circumference.

During the cleaning process, base section 21 is driven over by the vehicles to be washed and, in order to protect the vehicle tires, has for example a rounded cross section. Of course, the fashioning of a small drive-on ramp is also conceivable here.

FIG. 4 is a section along line B-B in FIG. 2. The two plates 14, converging downwardly toward each other in V fashion, form a mud channel from which the mud is withdrawn by dirt conveying apparatus 4 and removed from dirty water collecting vessel 1.

FIG. 5 is a section along line C-C in FIG. 2, through the two arm sections 22 of extension pipe 20, which are rectangular in cross section.

1. A tire washing station having a dirty water collecting vessel (1) over which there is a treatment passage (BE), which is to be driven through by a vehicle to be washed and on which there are disposed jet generators fed via a central supply system (10), wherein at least one extension flap (2) is disposed adjacently to the treatment passage (BE) and comprises an extension supply system (20), the extension supply system (20) feeding further jet generators fashioned on the extension flap (2).

2. The tire washing station of claim 1, wherein there are fashioned two extension flaps (2), which are disposed oppositely to each other adjacently to the treatment passage (BE).

3. The tire washing station of claim 1 or 2, wherein the expansion flap or flaps (2) are separably fastenable to the dirty water collecting vessel (1) and the extension supply system or systems (20) are separably connectable to the central supply system (10).

4. The tire washing station of one of claims 1 to 3, wherein the treatment passage (BE) and the extension flap or flaps (2) together form a drive-over surface whose length in the drive-through direction (P, P′) is at least 300 cm.

5. The tire washing station of one of claims 1 to 4, wherein the dirty water collecting vessel (1) is fashioned as open in the shape of a box or rectangular prism and the extension flap or flaps (2) each extend outwardly away from each other from the upper edges of mutually opposite side walls (12) of the dirty water collecting vessel (1).

6. The tire washing station of one of claims 1 to 5, wherein the extension flap or flaps (2) extend outwardly, each with an upward trend, from the dirty water collecting vessel (1) and/or exhibit a bottom having a gradient falling toward the dirty water collecting vessel (1) and preferably exhibit a wedge-shaped longitudinal section with the tip toward the dirty water collecting vessel (1).

7. The tire washing station of one of claims 1 to 6, wherein the extension supply system (20) is connected to the central supply system (10).

8. The tire washing station of one of claims 1 to 6, wherein the extension supply system (20) is connected directly to the dirty water collecting vessel (1) and has its own drive.
